(19) United States
(12) Patent Application Publication
(10) Pub. No.: US 2016/0226361 A1
(43) Pub. Date: Aug. 4, 2016

(54) Flat Linear Vibration Motor

(71) Applicants: Shun Guo, Shenzhen (CN); Lubin Mao, Shenzhen (CN); Hongxing Wang, Shenzhen (CN)

(72) Inventors: Shun Guo, Shenzhen (CN); Lubin Mao, Shenzhen (CN); Hongxing Wang, Shenzhen (CN)

(73) Assignee: AAC Technologies Pte. Ltd., Singapore city (SG)

(21) Appl. No.: 15/011,488

(22) Filed: Jan. 30, 2016

(30) Foreign Application Priority Data
Feb. 2, 2015 (CN) 201510053643.7

(51) Int. Cl. H02K 33/00

(52) U.S. Cl. CPC H02K 33/00

(57) ABSTRACT

A flat linear vibration motor is disclosed. The linear vibration motor includes a housing forming an accommodation space; a first magnet received within and fixed on the housing; a vibrator unit suspended within the housing, the vibrator unit including a clump weight, a third magnet, a driving magnet, a fourth magnet fixed on the clump weight and arranged along the vibration direction; a second magnet fixed on the housing, the second magnet, the first magnet, and the vibrator unit arranged in sequence along a vibration direction of the vibrator unit; an engaging assembly provided between the vibrator unit and the housing for suspending the vibrator unit in the accommodation space and enabling the vibrator unit sliding along the vibration direction of the vibrator unit; and a driving coil received in the accommodation space and opposed to the driving magnet.

### FIELD OF THE INVENTION

This invention relates to a type of vibration motor, especially a type of flat linear vibration motor which is used for those portable consumption electronic products.

### DESCRIPTION OF RELATED ART

With the development of electronic technology, portable consumption electronic products become more and more popular, such as cellphones, handheld game player, navigation device, or handheld multimedia recreation equipment, etc., vibration motor is usually used on these electronic products to make system feedback, such as cellphones call reminders, SMS tips, navigation tips, and vibration feedback of game players, etc. Such wide application requires that the vibration motor must be of high performance and long service life.

The vibration motor of relevant technology includes a housing, a vibrator unit that is received in the housing, and a spring part for suspending the vibrator unit within the housing. The spring part is also used to provide restoring force and provide localization guidance for the vibrator unit.

However, the vibrator unit of this vibration motor of such structure is easy to shake, moreover, the spring part is also easy to fail or wear in case of long time of service, all of which will affect badly the performance and service life of the motor.

Therefore, it is necessary to provide a new vibration motor to solve the problems mentioned above.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an isometric and exploded view of a flat linear vibration motor in accordance with a first exemplary embodiment of the present invention;

FIG. 2 is a cross-sectional view of the flat linear vibration motor in FIG. 1 along a longer axis thereof

FIG. 3 is an isometric of the flat linear vibration motor, only showing core components thereof.

FIG. 4 is a cross-sectional view of the flat linear vibration motor along a shorter axis.

FIG. 5 an engaging assembly cross-sectional view of a flat linear vibration motor in accordance with a second embodiment of the present disco sure.

### DETAILED DESCRIPTION OF THE EXEMPLARY EMBODIMENTS

The present invention will hereinafter be described in detail with reference to exemplary embodiments. It should be understood the specific embodiments described hereby is only to explain this disclosure, not intended to limit this disclosure.

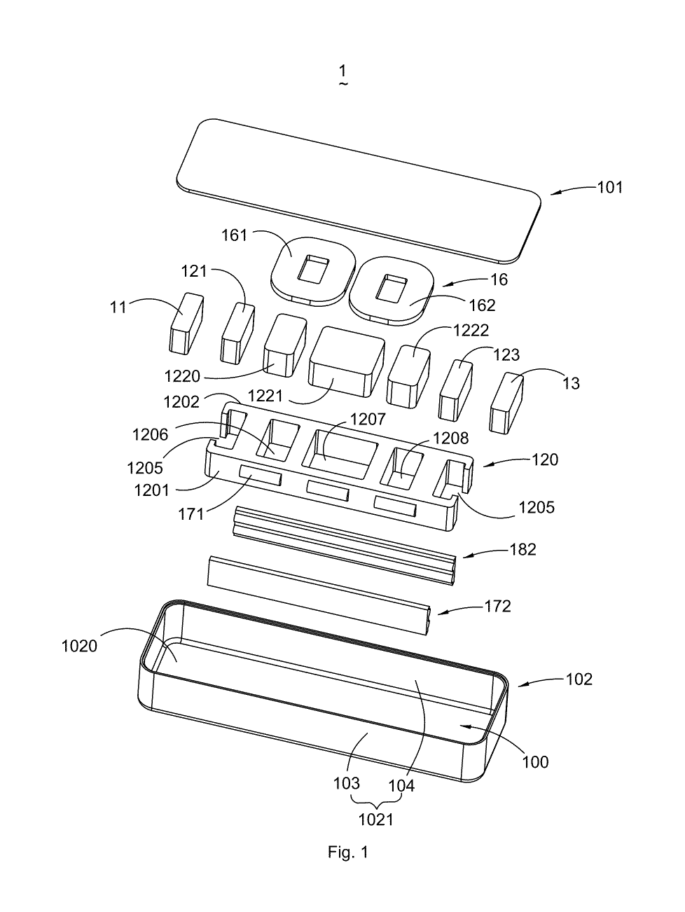

FIGS. 1-3 show a type of flat linear vibration motor 1 in accordance with a first exemplary embodiment of the present disclosure. The flat linear vibration motor 1 includes a long-strip housing 10 forming an accommodation space 100, a first magnet 11 received in the housing 10, a vibrator unit 12 suspended within the housing 10, and a second magnet 13 fixed on the housing 10. The first magnet 11, the vibrator unit 12, and the second magnet 13 are arranged in sequence along a vibration direction X-X of the vibrator unit 12. The flat linear vibration motor 1 further includes a driving coil 16 intervally set on an upper part of the vibrator unit 12 for driving the vibrator unit 12 to make reciprocating movement along the vibration direction X-X of the vibrator unit 12. The vibrator unit 12 further includes a pair of engaging assembly 17, and 18 arranged between the vibrator unit 12 and the housing and enabling the vibrator unit 12 being suspended within the housing 10, and enabling making the vibrator unit 12 moving along the vibration direction X-X.

The housing 10 includes an upper shell 101 and a lower shell 102 engaging with the upper shell 101 for forming the accommodation space 100. The lower shell 102 includes a bottom wall 1020 and a side wall 1021 extending from the bottom wall 1020. The first magnet 11 and the second magnet 13 are respectively fixed on the side wall 1021 of the lower shell 102, and are arranged on the inner side of the side wall 1021. The upper shell can be a plate shape, and also can be of the same shape with the lower shell 102, which can be designed into different shapes according to specific needs.

In FIG. 3, the vibrator unit 12 includes a long-strip clump weight 120, a third magnet 121 set along the vibration direction X-X, a driving magnet 122 and a fourth magnet 123 fixed on the clump weight 120. The third magnet 121 and the first magnet 11 are such configured that adjacent ends of the two magnets are spaced apart and have the same magnetic poles. The fourth magnet 123 and the second magnet 13 are such configured that adjacent ends of the two magnets are spaced apart and have the same magnetic poles. By virtue of the repulsive force generated by the first magnet 11, and the third magnet 121, and by the second magnet 13 and the fourth magnet 123, restoring force is generated for restricting the displacement of the vibrator unit 12 in the vibration direction X-X and for providing restoring force for the vibrator unit 12.

Referring to FIGS. 1, 2, and 4, the clump weight 120 includes a first outer side face 1201 and a second outer side face 1202 extending along the vibration direction X-X of the vibrator unit 12 and are set oppositely and intervally, during this exploitation case, preferably, the first outer side face 1201 is parallel to the second outer side face 1202. The side wall 1021 includes a first inner side face 103 and a second inner side face 104 which extend along the vibration direction X-X of the vibrator unit 12 and are respectively set oppositely and intervally with the above first outer side face 1201 and the second outer side face 1202, similarly, the first inner side face 103 and the second inner side face 104 are preferably set in parallel. The engaging assembly includes the first engaging assembly 17 which is set between the first outer side face 1201 and the first inner side face 103, and the second engaging assembly 18 which is set between the second outer side face 1202 and the second inner side face 104.

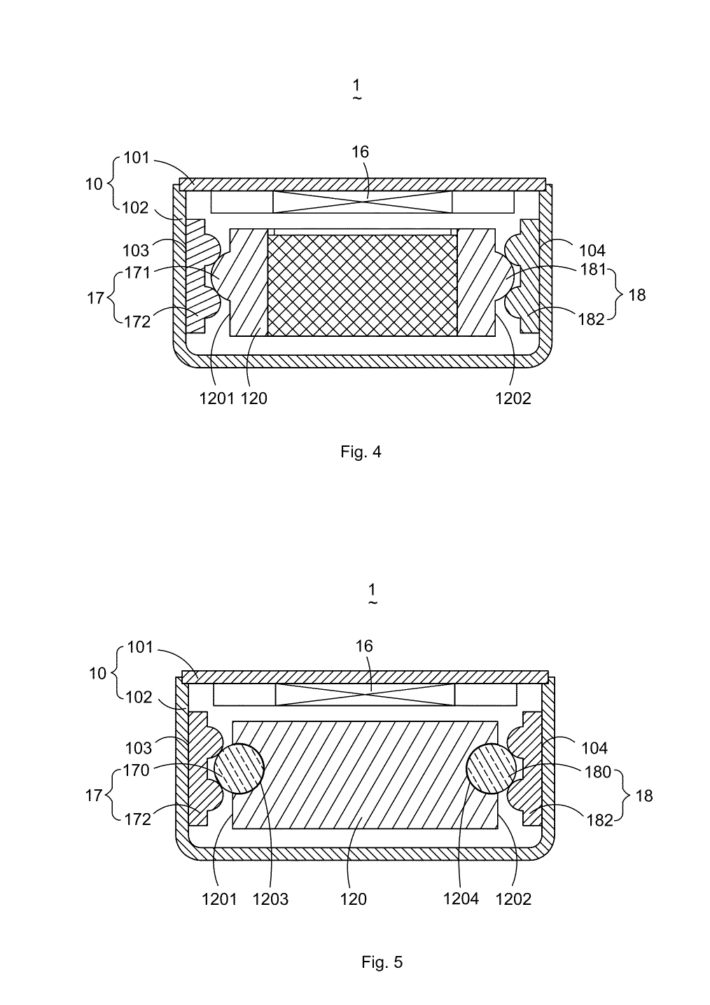

Referring also to FIG. 4, the first engaging assembly 17 includes a first guide rail part 171 fixed on the first outer side face 1201, and a first guide groove part 172 fixed on the first inner side face 103 and corresponding to the first guide rail 171. The second engaging assembly 18 includes a second guide rail part 181 fixed on the second outer side face 1202, and a second guide groove part 182 fixed on the second inner side face 104 and corresponding to the second guide rail part 181. The suspension of the vibrator unit 12 within the housing 10 can be realized through the sliding cooperation of the first guide rail part 171 and the first guide groove part 172 as well as the second guide rail part 181 and the second guide groove part 182, and the movement of the vibrator unit 12 along the vibration direction X-X can also be achieved.

The structures of the first engaging assembly 17 and the second engaging assembly 18 are not limited to the above-mentioned structures. As shown in FIG. 5, in a second exemplary embodiment of the present disclosure, a first groove 1203 is set along the vibration direction X-X of the vibrator unit 12, the first engaging assembly 17 includes a first guide groove part 172 which is set on the first inner side face 103 which is matched with the first groove 1203, and a first roll ball 170 which is set between the first groove 1203 and the first guide groove 172. A second groove 1204 is set on the second outer side face along the vibration direction X-X of the vibrator unit 12, the first engaging assembly 18 includes A second guide groove part 182 which is set on the second inner side face 104 which is matched with the second groove 1204 where the guide groove is set, and a second roll ball 180 which is set between the second groove 1204 and the second guide groove 182. Through the rolling of the first roll ball 170 between the first groove 1203 and the first guide groove 172 as well as the second roll ball 180 between the second groove 1204 and the second guide groove part 182, the suspension of the vibrator unit 12 within the housing 10 can be realized, and the movement of the vibrator unit 12 along the vibration direction X-X can also be achieved.

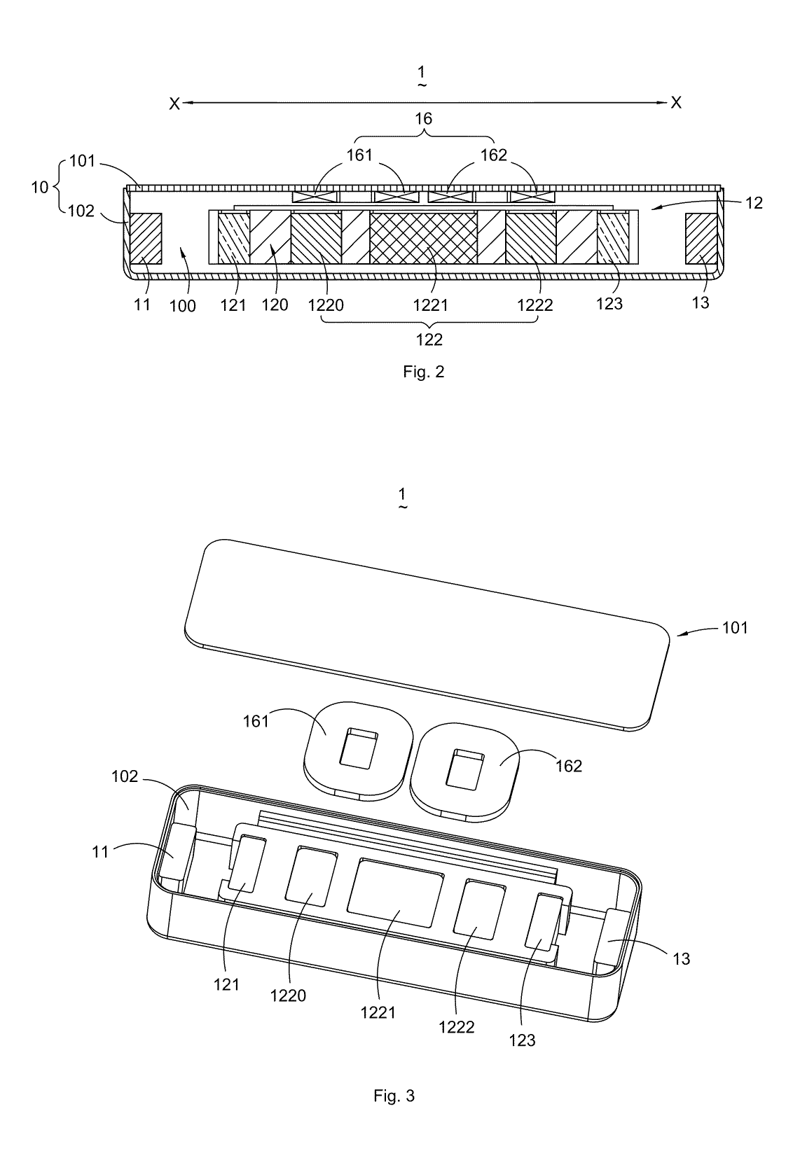

Referring back to FIGS. 1-2, the driving magnet 122 is magnetized along the thickness direction of the vibration motor 1, the driving coil 16 comes in a flat-ring shape, and is received in the receiving space 100, and is intervally set with the driving magnet 122. After being powered on, the driving coil 16 will receive Ampere force in the magnetic field generated by the driving magnet 122, receiving the reactive force of this Ampere force, the driving magnet 122 will further push the vibrator unit 12 to make reciprocating movement along the vibration direction of the vibrator unit 12 X-X.

The driving magnet 122 includes a fifth magnet 1220, a sixth magnet 1221, and a seventh magnet 1222 which are set intervally in sequence along the vibration direction X-X of the vibrator unit 12. The fifth magnet 1220 and the seventh magnet 1222 are of the same magnetizing direction, and the sixth magnet 1221 and the seventh magnet 1222 are of the opposite magnetizing directions. The driving coil 16 includes a first driving coil 161 which is assembled on the upper parts of the fifth magnet 1220 and the sixth magnet 1221, and a second driving coil 162 which is assembled on the upper parts of the sixth magnet 1221 and the seventh magnet 1222, therefore, after 2 5 powered on, the first driving coil 161 will receive Ampere force in the magnetic field generated by the fifth driving magnet 1220 and the sixth magnet 1221, and after being powered on, the second driving coil 162 will receive Ampere force in the magnetic field generated by the sixth driving magnet 1221 and the seventh magnet 1222.

Slots 1205 are respectively set on the clump weight 120 on both ends of the vibration direction X-X of the vibrator unit 12, the third magnet 121 and the fourth magnet 123 are respectively fixed within the slots 1205. A first through-hole 1206, a second through-hole 1207, and a third through-hole 1208 are respectively set on the positions of the clump weight 12 which corresponds to the fifth magnet 1220, the sixth magnet 1221, and the seventh magnet 1222 which are used to receive the above three magnets 1220, 1221, and 1222, and go through the clump weight 12.

By utilizing the repulsive force generated by opposite magnetic poles between the magnets to provide restoring force, and utilizing the engaging assembly to provide localization guidance for the vibrator unit 12, the flat linear vibration motor 1 provided by this invention can effectively avoid the influence on the performance and service life of the vibration motor due to the failure and wear of the spring part of the traditional vibration motor, in the meantime, using the engaging assembly to provide localization guidance can effectively avoid the polarization of the vibrator unit 12 during the vibration, and effectively improve the performance of the vibration motor 1.

It is to be understood, however, that even though numerous characteristics and advantages of the present embodiment have been set forth in the foregoing description, together with details of the structures and functions of the embodiment, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A type of flat linear vibration motor, including:
a housing forming an accommodation space;
a first magnet received within and fixed on the housing;
a vibrator unit suspended within the housing, the vibrator unit including a clump weight, a third magnet, a driving magnet, a fourth magnet fixed on the clump weight and arranged along a vibration direction of the vibrator unit; the third magnet being such configured that a magnetic pole thereof is similar to an adjacent magnetic pole of the first magnet;
a second magnet fixed on the housing, the second magnet, the first magnet, and the vibrator unit arranged in sequence along a vibration direction of the vibrator unit; the second magnet being such configured that a magnetic pole thereof is similar to an adjacent magnetic pole of the fourth magnet;
an engaging assembly provided between the vibrator unit and the housing for suspending the vibrator unit in the accommodation space and enabling the vibrator unit sliding along the vibration direction of the vibrator unit;
a driving coil received in the accommodation space and opposed to the driving magnet.

2. The flat linear vibration motor as described in claim 1, wherein the housing includes an upper shell and a lower shell engaging with the upper shell for forming the accommodation space, the lower shell includes a bottom wall and a side wall extending from the bottom wall, the first magnet and the second magnet are respectively fixed on the side wall of the lower shell.

3. The flat linear vibration motor as described in claim 1, wherein the clump weight includes a first outer side face and a second outer side face opposed to the first outer side face, and the housing includes a first inner side face opposed to the first outer side face and a second inner side face opposed to the second outer side face, the engaging assembly includes a first engaging assembly provided between the first outer side face and the first inner side face, and a second engaging assembly disposed between the second outer side face and the second inner side face.

4. The flat linear vibration motor as described in claim 3, wherein the first outer side face and the second outer side face extend along the vibration direction of the vibrator unit, the first inner side face and the second inner face extend along the vibration direction of the vibrator unit.

5. The flat linear vibration motor as described in claim 1, wherein slots are respectively provided on both ends along the longer axis of the clump weight, for positioning the third magnet and the fourth magnet.

6. The flat linear vibration motor as described in claim 1, wherein the driving magnet includes a fifth magnet, a sixth magnet, and a seventh magnet which are intervally set in sequence along the vibration direction.

7. The flat linear vibration motor as described in claim 6, wherein the fifth magnet and the seventh magnet are of the same magnetizing direction, the sixth magnet and the seventh magnet are of opposite magnetizing directions, the driving coil includes a first driving coil assembled on upper parts of the fifth magnet and the sixth magnet, and a second driving coil assembled on upper parts of the sixth magnet and the seventh magnet.

8. The flat linear vibration motor as described in claim 3, wherein the first engaging assembly includes a first guide rail fixed on the first outer side face, and a first guide groove part fixed on the first inner side face and corresponding to the first guide rail, the second engaging assembly includes a second guide rail fixed on the second outer side face, and a second guide groove part fixed on the second inner side face and corresponding to the second guide rail, the cooperation between the guide rails and guide grooves suspends the vibrator unit within the housing for enabling the vibrator unit sliding along the vibration direction.

9. The flat linear vibration motor as described in claim 3, wherein a first groove is provided on the first outer side face along the vibration direction, the first engaging assembly includes a first guide groove part on the first inner side face corresponding to the first groove, and a first roll ball disposed between the first groove and the first guide groove part, a second groove is provided on the second outer side face along the vibration direction, the second engaging assembly includes a second guide groove part on the second inner side face corresponding to the second groove, and a second roll ball is provided between the second groove and the second guide groove part.
